(19) United States
(12) Patent Application Publication
(10) Pub. No.: US 2017/0372553 A1
(43) Pub. Date: Dec. 28, 2017

(54) Single Cigarrette Vending Machine

(71) Applicant: Brett Gray, Naperville, IL (US)

(72) Inventor: Brett Gray, Naperville, IL (US)

(21) Appl. No.: 15/632,033

(22) Filed: Jun. 23, 2017

Related U.S. Application Data
(60) Provisional application No. 62/354,226, filed on Jun. 24, 2016.

(51) Int. Cl. G07F 7/02; G07F 7/08; G07F 11/00; G07F 11/10

(52) U.S. Cl. CPC G07F 7/025; G07F 11/005; G07F 7/0886; G07F 11/10

(57) ABSTRACT

A cigarette vending machine that dispenses a single cigarette at a time. The cigarette vending machine includes a touchscreen that allows a user to select a particular brand of cigarettes. In addition, the vending machine includes a camera and an identification reader so that the user's age can be verified, and so that the user can be verified to be the same person as the identification holder.

### FIELD OF THE DISCLOSURE

The present disclosure generally relates to vending machines. More particularly, the present disclosure relates to vending machines for dispensing tobacco products. More particularly still, the present disclosure relates to vending machines for dispensing cigarettes, and even more particularly still, the present disclosure relates to age verified vending machines with a touchscreen interface that dispense single cigarettes within specialized vendor packaging.

### BACKGROUND

Vending machines for dispensing various products are well known in the art. For example, vending machines for beverages and snacks are ubiquitous in public locations such as rest stations, museums, and theme parks (to name a few locations). Prior art vending machines for snacks often use a series of visible “cells,” with each cell using a coil to hold food (or something else) in place. A user can view the food through a transparent window (usually covering the entire front of the vending machine). A product is dispensed when the coil of the selected product rotates one full revolution, and causes the object (food or the like) to drop into a receptacle where it can be retrieved by the user.

Vending machines have also been used—mostly in the past—to dispense tobacco products. For example, it was previously common to purchase packs of cigarettes from vending machines. Generally, prior art cigarette vending machines worked by using a series of trays within which cigarette packages are packed. A user would select her favored brand, deposit sufficient funds, and depress a button or plunger which would cause one pack of the selected brand of cigarettes to be released into a receptacle for the user. Vending machines have also been used commercially to dispense cigars—generally as single units—chewing tobacco, and tobacco for making self-rolled cigarettes.

More recently, modern vending machines have used LCD displays with external controls, as well as LCD displays with touch screens to select various products. For example, for modern soda vending machines, different syrup dispensers can be used for different brands of soda; in some cases, different syrup/water mixing instructions (ratio) is utilized as well. Based on a user's selection on a touch screen, a particular soda mix can be dispensed into a waiting cup.

Touch screen based interfaces have also been used for vending machines that dispense other types of products. For example, coil based dispensers have been used with LCD interfaces to dispense food and tray based dispensers have been used to dispense bottles and cans of soft drinks and even cell phones.

One problem with prior art cigarette vending machines is that they generally dispensed one pack at a time, rather than a single cigarette. For a person attempting to stop smoking, an entire pack of cigarettes is an invitation to rekindle an addiction, rather than an opportunity to squelch an irresistible urge prior to resuming an effort to stop smoking. In addition, prior art cigarette vending machines did not utilize LCD based interfaces. Another issue with prior art cigarette vending machines is that they allowed under aged persons to purchase entire packs of cigarettes.

### OBJECTS OF THE DISCLOSED SYSTEM, METHOD, AND APPARATUS

Accordingly, it is an object of this disclosure to provide a vending machine to dispense single cigarettes.

Another object of the disclosure is to provide a vending machine with a modern interface for dispensing single cigarettes.

Another object of the disclosure is to provide a vending machine with a method of verifying the person's age.

Other advantages of this disclosure will be clear to a person of ordinary skill in the art. It should be understood, however, that a system or method could practice the disclosure while not achieving all of the enumerated advantages, and that the protected disclosure is defined by the claims.

### SUMMARY OF THE DISCLOSURE

A cigarette vending machine for dispensing a single cigarette at a time is disclosed. The vending machine comprises a housing and a touchscreen disposed on the housing so that the user can select a particular brand of cigarette. In addition, the vending machine includes a payment processor that can accept, for example, bills, coins, credit cards and cell phone payments. Disposed within the housing is a plurality of trays, each of which holds a plurality of a single brand of cigarettes. Each dispensing tray also includes a spring disposed on a back wall of the dispensing tray that applies force on a plate that extends laterally across the dispensing tray to force the cigarettes forward. The dispensing trays also include a cigarette dispensing mechanism, which can be, for example, a microcontroller controlled hydraulic piston.

A microcontroller monitors the touchscreen and payment processor to determine if payment has been provided for a particular cigarette. If so, the microcontroller activates the cigarette dispensing mechanism for the correct dispensing tray, and dispenses a single cigarette.

In certain embodiments, the cigarette vending machine includes an identification reader and a camera. The identification holder's age can be verified from the user's identification, and the camera can be used to verify that the user is the same person as the identification holder.

### BRIEF DESCRIPTION OF THE DRAWINGS

Although the characteristic features of this disclosure will be particularly pointed out in the claims, the invention itself, and the manner in which it may be made and used, may be better understood by referring to the following description taken in connection with the accompanying drawings forming a part hereof, wherein like reference numerals refer to like parts throughout the several views and in which:

FIG. 1 is a perspective view of a vending machine constructed in accordance with this disclosure;

FIG. 2 is a top view of a cigarette dispensing tray constructed in accordance with this disclosure;

FIG. 3 is a perspective view of a cigarette dispensing tray constructed in accordance with this disclosure;

FIG. 4 is a block diagram of internal mechanisms of a cigarette vending machine constructed in accordance with this disclosure;

FIG. 5 is a depiction of a possible first user interface screen constructed in accordance with this disclosure; and

FIG. 6 is a depiction of a possible second user interface screen constructed in accordance with this disclosure.

### DETAILED DESCRIPTION

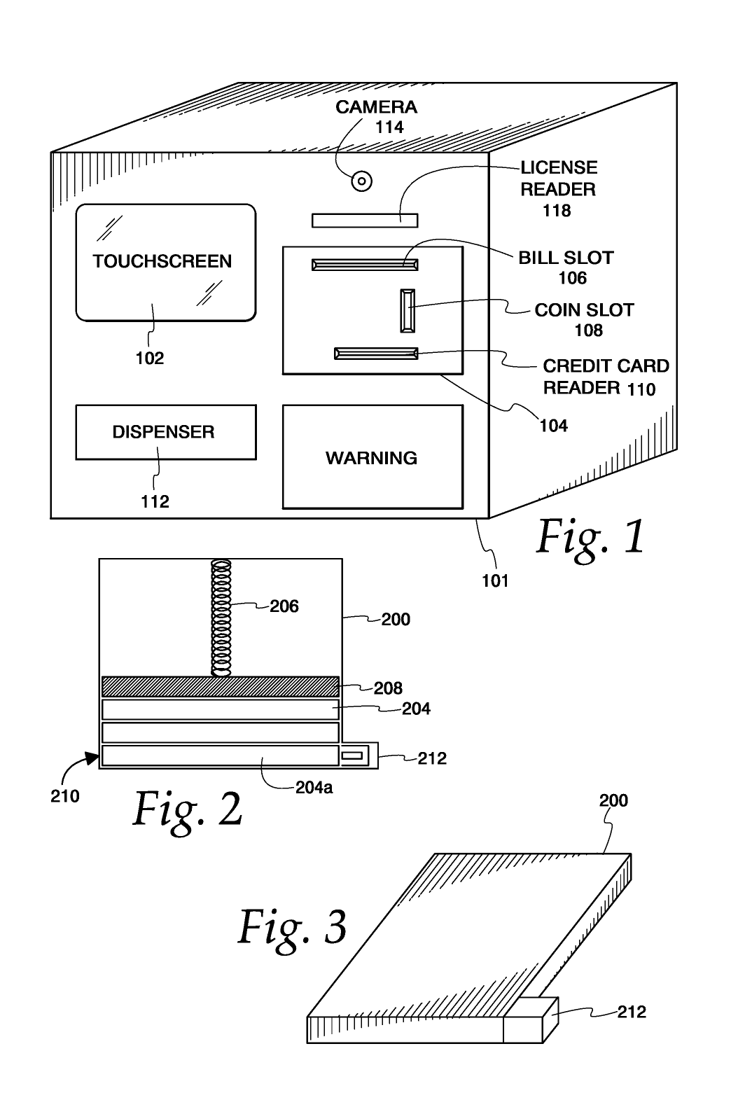

Turning to the Figures and to FIG. 1 in particular, a perspective view of a vending machine constructed in accordance with this disclosure is depicted. As illustrated, the vending machine can dispense single cigarettes wherein each cigarette can be wrapped in manufacturer approved packaging, although the latter is not a limitation of the disclosure. As depicted, the vending machine 100 includes a housing 101, a touchscreen 102 through which a user can input a selected cigarette. The vending machine also comprises a payment panel 104, which includes a bill acceptor 106, a coin slot 108, and a credit card/driver's license reader 110. The payment panel 104 can also incorporate a NFC link or other wireless link to enable cell phone payment. The vending machine also includes a dispenser 112, and, in the depicted embodiment, a camera 114 and an identification reader 118.

As the vending machine 100 dispenses a single cigarette, the packaging—likely a thin paper or plastic wrapper—may not have sufficient room to include the warnings required by most countries to be posted on tobacco products in general, and cigarettes in particular. Accordingly, the depicted embodiment of the vending machine includes a panel 116 where the required warning can be displayed.

The disclosed vending machine 100 offers the advantage of dispensing a single cigarette; so that, for example, an addict can satisfy a passing urge with a single cigarette rather than buying an entire pack; given the way that addiction works, an addict would find it extremely difficult to not smoke the entire pack. In addition, using the camera 114 and license reader 118, a person's identification and eligibility to purchase cigarettes can be verified.

Turning to FIGS. 2 and 3, a mechanical dispensing tray 200 is depicted. Each dispensing tray 200 incorporates a single brand of cigarette 204. The vending machine 100 will have many trays mounted vertically, one above the other. Each dispensing tray 200 houses a plurality of cigarettes 204, which are pushed toward the front of the tray by plate 208, which is subjected to constant force by spring 206. Each dispensing tray 200 also includes an aperture 210 on one side of the tray positioned so that the front most cigarette 204a is disposed adjacent to the aperture 210.

Each dispensing tray 200 also includes a hydraulic piston 212. The hydraulic piston 212 is activated by an external controller (discussed below) to dispense the front most cigarette 204a. In particular, when activated, the hydraulic piston 212 extends, knocks the front most cigarette 204a through the aperture. The front most cigarette 204a then falls down an internal slide (not pictured) to the dispenser 112 of the vending machine.

It should be noted that the dispensing tray 200 of FIGS. 2 and 3 can be sized to accept standard sized cigarettes, such as 100s and 120s, as well as abnormally sized cigarettes. As each tray only holds one brand of cigarettes, different sizes can be accommodated simply by using different size trays.

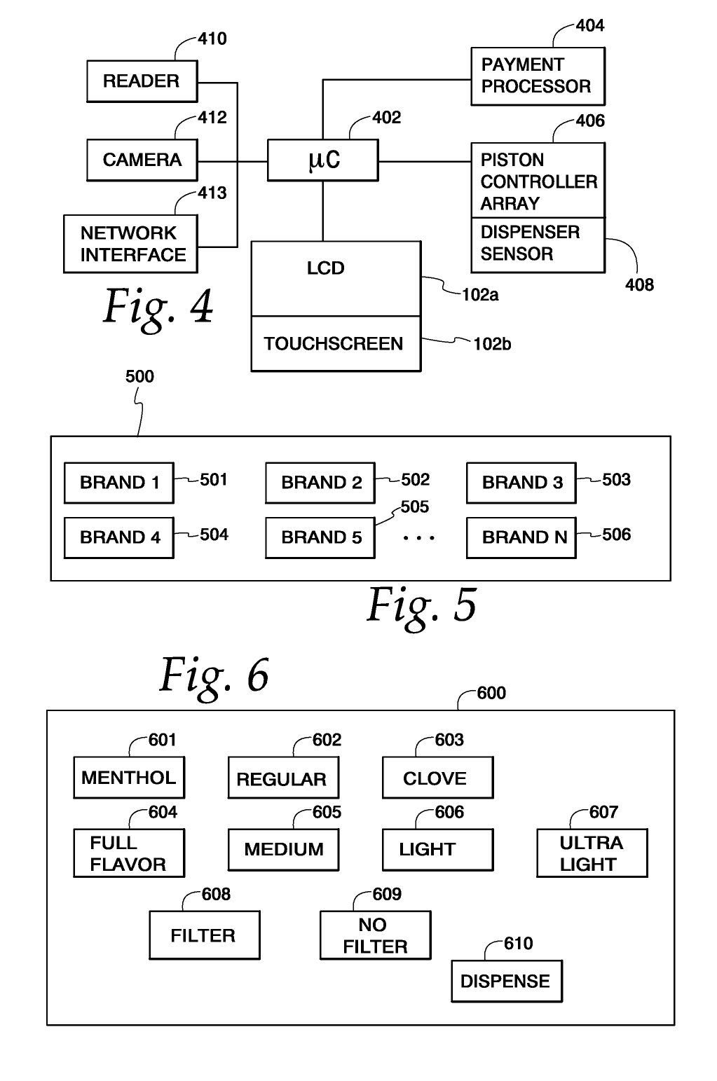

FIG. 4 depicts a block diagram illustrating how the different components of a vending machine 100 constructed in accordance with this disclosure. In particular, a microcontroller 402 is coupled to the LCD/touchscreen 102. The microcontroller 402 causes the LCD 102a to display menus for the user to select from, and accepts input from the touchscreen 102b. The microcontroller 402 is notified of the amount of payment made by the payment processor 404, and, in response, will dispense cigarettes with the piston controller array 406 and dispenser sensor 408. In particular, a program operating on the microcontroller 402 will cause a particular piston controller within the piston controller array 406 to operate until the dispenser sensor 408 detects that a cigarette that has been dropped.

The microcontroller 402 is also coupled to an identification reader 410 and a camera 412. In one embodiment of the disclosed vending machine 100, the user must verify her age before being allowed to purchase cigarettes. The user would be required to input her identification into the identification reader 410. The user's identification would then be scanned by the identification reader. Based on an indicia in the user's identification, a high resolution picture of the user's face may be retrieved from an external database (not shown) using network interface 413. Alternatively, a picture of the user's face can be extracted from the user's identification. For example, all state driver licenses contain a picture of the driver's face, which could be captured from the license. The user would then be required to present her face to the camera 114. The microcontroller 402 then uses a facial analysis algorithm on both the user's face and the face captured from the user's identification. If the user's face is a close enough match for that extracted from the user's identification, and the user's identification indicates that the user is of sufficient age to purchase cigarettes, the user will be allowed to purchase cigarettes.

FIG. 5 depicts a first user interface screen 500 and menu for use with a vending machine constructed in accordance with the disclosure. The first user interface screen 500 comprises a sequence of selections. Using this screen, the user can select one of the brands that the vending machine stocks. As depicted, six brands 501,502,503,504,505,506 are depicted, although it should be understood that any number of brands could be stocked; if the stocked brands would not fit on one screen, additional screens could easily be displayed using methods well known in the art, such as a “More Brands” selection button.

Once a user makes a selection from the first user interface screen 500, the user is taken to a second user interface screen 600, an embodiment of which is depicted in FIG. 6. The second user interface screen 600 allows a user to refine her selection by specifying the type of cigarette (within the selected brand) that the user desires. In particular, the second screen allows a user to select a Menthol 601 cigarette, a Regular 602 cigarette, or a Clove 603 cigarette. Similarly, a user can select a Full Flavor 604 cigarette, a Medium 605 cigarette, a Light 606 cigarette, or an Ultra Light 607 cigarette. In addition, a user can select a cigarette with a Filter 608, or a cigarette with No Filter 609. When a user has finished specifying her desired cigarette, the user can select the Dispense 610 button, which will cause the selected cigarette to actually be dispensed.

In certain circumstances, a particular brand may not offer cigarettes with all of the listed options, or a particular option might be sold out. In such a circumstance, the characteristic that is not offered could be grayed out or not presented to the user at all. For example, if a user selected “Brand 1,” and “Brand 1” does not offer Clove cigarettes, the “Clove” button 603 would be grayed out or not presented to the user at all. Similarly, if “Brand 1” does offer Clove cigarettes, but all of the Clove cigarettes offered by the vending machine have already been dispensed, the “Clove” button 603 would be grayed out or not presented to the user at all.

The foregoing description of the disclosure has been presented for purposes of illustration and description, and is not intended to be exhaustive or to limit the disclosure to the precise form disclosed. The description was selected to best explain the principles of the present teachings and practical application of these principles to enable others skilled in the art to best utilize the disclosure in various embodiments and various modifications as are suited to the particular use contemplated. It is intended that the scope of the disclosure not be limited by the specification, but be defined by the claims set forth below. In addition, although narrow claims may be presented below, it should be recognized that the scope of this invention is much broader than presented by the claim(s). It is intended that broader claims will be submitted in one or more applications that claim the benefit of priority from this application. Insofar as the description above and the accompanying drawings disclose additional subject matter that is not within the scope of the claim or claims below, the additional inventions are not dedicated to the public and the right to file one or more applications to claim such additional inventions is reserved.

What is claimed is:

1. A cigarette vending machine for dispensing a single cigarette at a time, the cigarette vending machine comprising:
a) a housing;
b) a touchscreen disposed on the housing and adapted to accept a selection of a particular cigarette brand from a user wherein the touchscreen generates a signal indicative of a selected cigarette brand;
c) a payment processor disposed on the housing and adapted to accept payment from a user wherein the payment processor generates a signal indicative of the amount of payment received;
d) a plurality of dispensing trays vertically disposed within the housing wherein each of said plurality of dispensing trays holds a plurality of cigarettes of a single brand and wherein each dispensing tray includes a cigarette dispensing mechanism; and
e) a microcontroller coupled to the touchscreen, the payment processor, and the plurality of dispensing trays;
f) wherein the microcontroller 1) receives the signal indicative of a selected cigarette brand and the signal indicative of the amount of payment received, 2) receives the signal indicative of the amount of payment received, and 3) selectively activates a particular cigarette dispensing mechanism based on the signal indicative of a selected cigarette brand and the signal indicative of the amount of payment received.

2. The cigarette vending machine of claim 1 wherein each of the plurality of dispensing trays comprises:
a front wall, a back wall, a left wall, a right wall, a top and a bottom;
a plate stretching from nearly the left wall to nearly the right wall, and sized so as to reach from nearly the bottom to nearly the top; and
a spring coupled to the back wall so as to apply pressure to the plate.

3. The cigarette vending machine of claim 1 wherein the cigarette dispensing mechanism is a hydraulic piston.

4. The cigarette vending machine of claim 1 further comprising a camera coupled to the microcontroller and an identification reader coupled to the microcontroller and wherein the microcontroller further verifies the user's age using the camera and identification reader.

5. The cigarette vending machine of claim 4 further comprising a network interface coupled to the microcontroller and wherein the identification reader is adapted to accept an identification from a user, and wherein the microcontroller is adapted to retrieve an age for the user and a baseline image of the user's face using the network interface, and wherein the camera is adapted to capture a second picture of the user's face, and wherein the microcontroller compares the second picture of the user's face to the baseline picture of the user's face.

6. The cigarette vending machine of claim 1 further comprising a display coupled to the microcontroller and wherein the microcontroller operates the display to show a plurality of cigarette brands corresponding to the cigarette brands contained in the plurality of dispensing trays.
